(19) United States
(12) Patent Application Publication
(10) Pub. No.: US 2002/0085025 A1
(43) Pub. Date: Jul. 4, 2002

(54) Universal electronic commerce platform combining browsing, buying and item registry

(76) Inventors: James R. Busis, Pittsburgh, PA (US); Daniel Droz, Pittsburgh, PA (US); Louis Weiss, Pittsburgh, PA (US); Joel Lenhart, Pittsburgh, PA (US); Chris Umbel, Pittsburgh, PA (US); Matthew S. Meyers, Pittsburgh, PA (US); Evan M. Indianer, Pittsburgh, PA (US); Richard P. Aranson, Pittsburgh, PA (US); Christopher D. Kasabach, Pittsburgh, PA (US); Christopher D. Pacione, Pittsburgh, PA (US); John M. Stivoric, Pittsburgh, PA (US); Eric Teller, Pittsburgh, PA (US)

Correspondence Address: Metz Schermer & Lewis, LLC, 18th Floor, 11 Stanwix Street, Pittsburgh, PA, 15222, US

(21) Appl. No.: 09/895,983

(22) Filed: Jun. 29, 2001

Related U.S. Application Data
(60) Provisional application No. 60/214,887, filed on Jun. 29, 2000.

(51) Int. Cl. G09G 5/00

(52) U.S. Cl. 345/738

(57) ABSTRACT

An electronic commerce system that enables people to capture their desires and helps to facilitate fulfillment of these desires. The system allows for creating and maintaining lists that include items desired by system users. Client devices and kiosks located at or near a merchant location are connected to an electronic network for collecting data relating to the desired items. A server receives the data relating to the desired items and a data storage device coupled to the server stores information relating to the desired items. The server transmits information to a requesting party to enable that party to view the lists. Also provided are systems and methods for adding information to the lists, finding and fixing non-functioning URLs, and for the splitting the economic value of originally enticing consumers to desire an item from the economic value of enticing or enabling consumers to purchase that item.

### CROSS REFERENCE TO A RELATED APPLICATION

This application claims the benefit of United States Provisional Application No. 60/214,887, filed on Jun. 29, 2000.

### FIELD OF THE INVENTION

The present invention relates to a tool for facilitating the capture, organization and fulfillment of people's wants, needs and desires, and in particular to a universal electronic commerce platform combining browsing, buying and item registry functionality.

### BACKGROUND

As people's lives become busier and busier, and demands for people's time becomes greater and greater, it becomes harder for people to organize and manage their lives. The unfortunate result of such increased demands is that people's wants, needs and desires often go overlooked and unfulfilled. Thus, a great need exists for a tool that facilitates in a simple and readily accessible way the capture, organization and fulfillment of people's wants, needs and desires. One prior art example of a tool aimed at helping people to organize a certain aspect of their lives is a traditional gift registry. In a traditional gift registry, a person or persons typically visit a retail store and prepare a list of items that they would like to receive for a particular occasion. For example, a soon to be married couple often uses a gift registry to list the items they would like to receive as shower and/or wedding gifts. The person or persons preparing the list then lets other people know where they have registered so that those other people can visit the store, view the list, and purchase one of the listed items as a gift for the person or persons preparing the list. The purchased item can then be taken off the list or marked as purchased so that duplicate items will not be purchased.

Many retailers have taken to computerizing their gift registry systems. Typically, such a retailer will maintain each person's or persons' list of items in a central database that is accessible through a computer provided in the retailer's store. People desiring to purchase a gift can visit the store, view and possibly print the registry list, and locate and purchase an item. Because the registry lists are maintained in a central database, a retailer that has a large number or chain of stores, such as a large department store, or a small group of closely linked or affiliated retailers, can provide the same list to potential purchasers at multiple locations, and can track the purchases made from the list from those multiple locations.

A traditional gift registry is thus a tool that helps people to capture and organize their wants and desires. Traditional gift registries, however, have several limitations that restrict their usefulness as a broad organizational tool. First, traditional gift registries are typically used in connection with specific occasions, such as a wedding or shower, and thus their usefulness as an organization tool is limited to that specific occasion. Traditional gift registries are also typically limited to one retailer or a small group of closely linked retailers, and thus to the specific items sold by that one retailer or small group of closely linked retailers. The specific items sold by the retailer or small group of closely linked retailers are obviously particular branded items. People can thus not use traditional gift registries to list a non-specific, non-branded item, leaving the choice of the particular item within a category to the purchaser.

What is needed and what is lacking in the prior art is an organizational tool that is universal in its functionality and applicability in that it is not limited to a particular retailer and thus the items of a particular retailer and that is not limited to a particular event or occasion. With such a tool, a person could freely capture and organize their wants and desires, whatever they may be. Such a tool, by using the Internet and its myriad functionality, would greatly facilitate fulfillment of these wants and desires by making them readily accessible to third parties and by providing the third parties with means for satisfying the wants and desires.

### SUMMARY OF THE INVENTION

The present invention is an electronic commerce system available on an electronic network such as the Internet and in retail environments that enables people to capture their desires and helps to facilitate fulfillment of these desires.

One embodiment of the present invention relates to a system for creating and maintaining a plurality of lists associated with one of a plurality of system users. The lists include one or more items desired by each user. The system includes a plurality of client devices connected to an electronic network for collecting data relating to the desired items. The system also includes a plurality of kiosks located at or near a merchant location for collecting data relating to desired items. The kiosks are also connected to the electronic network. A server is provided for receiving the data relating to the desired items from the client devices and the kiosks over the electronic network. A data storage device is coupled to the server for retrievably storing information relating to the desired items, the information including the data relating to the desired items. The server, in response to a request to view a selected one of the lists associated with a selected one of the users received over the electronic network from a requesting party, retrieves from the storage device selected pieces of the information relating to the desired items and transmits the selected pieces of information to the requesting party over the electronic network.

In one implementation, the system may be universal in nature, with no connection to a particular retail store. The system may also be implemented in connection with a retail store's own in-house registry system or in connection with a retail store's own Internet enabled registry system. Alternatively, the system may be implemented by a retail store in connection with a universal registry system maintained by a third party over the Internet. Furthermore, the system has application in both a business to consumer setting, where, for example, less expensive scanning equipment may be used and perhaps owned by ultimate consumers, and in a business to business setting, where, for example the system is implemented in connection with a retail store and more complex and expensive scanning equipment is used.

An alternate embodiment of the present invention relates to an item registry system maintained by a system provider where the system maintains a plurality of lists, each list being associated with one of a plurality of system users. The lists include one or more items desired by the associated user. The system contemplates a method of sharing revenue from the sale of the listed desired items among the system provider and one or more of a plurality of sellers affiliated with the system provider. According to the method, data relating to the desired items is received from the users over an electronic network, such as the Internet, and stored when the desired items are added to the lists by the users. The data for each of the desired items includes an identification of a first seller credited with enticing the user to add the desired item to the user's list. The lists are made available to the users and a plurality of third parties over the electronic network. Data relating to a purchase of one of the desired items is received from a second seller and stored. A determination is made as to whether the second seller is one of the affiliated sellers. If the second seller is one of the affiliated sellers, the second seller pays: (i) a first fee to the system provider, and (ii) a second fee to the first seller if the first seller is different from the second seller and if the first seller is one of the affiliated sellers. This method, which tracks an item from the point of origin of the desire to have the item to the point of its ultimate purchase, allows for the splitting of the economic value of originally enticing individual consumers to desire an item from the economic value of enticing or enabling them or others to purchase that item.

A further alternate embodiment of the present invention relates to system for maintaining a plurality of lists, each of the lists being associated with one of a plurality of system users. The lists include one or more items desired by the user associated with the list. The system includes a server for receiving data relating to the desired items over an electronic network from each of the users and a data storage device coupled to the server for retrievably storing the data. The server, in response to a request from one of the users, causes a list window to open on a client device under the control of the requesting user. The list window is adapted to display a listing of the desired items included on the list associated with the requesting user. In addition, the server provides the client device with instructions executable by the client device. The instructions, when executed in response to a request from the user to add to the list an item shown in a web page being displayed in a first window on the client device, cause the client device to copy a uniform resource locator used to identify the web page from the web page to the list window. The client devices may be adapted to enable users to input additional information relating to the item shown in the web page into the list window and to transmit the uniform resource locator and the additional information shown in the web page to the server for storage. As a result, users are able to simply and easily add items and information to their stored lists. Moreover, the server, in response to a request from a requesting party, may be adapted to cause a list window to open on either a client device or a kiosk under the control of the requesting party, wherein the list window is adapted to display a listing of the items included on the list associated with a selected one of the users. The requesting party may use the list to purchase, online or offline, one or more of the items on the list.

In an alternative embodiment of this system, the instructions, when executed in response to a request to add to the list associated with the requesting user an item shown in a web page having a known template structure being displayed in a first window on the client device, cause the client device to: (i) locate certain preselected information in the web page based on the known template structure; and (ii) copy the preselected information from the web page to the list window. The preselected information may include one or more of a uniform resource locator used to identify the web page, a price of the item shown in the web page, and a description of the item shown in the web page.

In a further alternative embodiment of this system, the instructions, when executed in response to a request to add to the list associated with the requesting user an item shown in a web page being displayed in a first window on the client device, cause the client device to: (i) search the web page for one or more preselected patterns of information contained in the web page; and (ii) when the one or more preselected patterns of information are found, copy certain preselected information associated with the one or more preselected patterns of information from the web page to the list window.

In a still further alternative embodiment of this system, the instructions, when executed in response to a request from to add to the list associated with one of the users an item shown in a web page being displayed in a first window on the client device, cause the client device to copy a uniform resource locator used to identify the web page from the web page and transmit the uniform resource locator to the server. In this alternative, the server stores instructions that, upon receipt of the uniform resource locator, cause the server to: (i) determine whether the web page has a known template structure; (ii) if the web page has a known template structure, access the web page using the uniform resource locator and locate certain preselected information in the web page based on the known template structure; and (iii) copy the preselected information from the web page and store the preselected information in the data storage device. If the web page does not have a known template structure, the instructions cause the server to: (i) access the web page using the uniform resource locator and search the web page for one or more preselected patterns of information contained in the web page; and (ii) when the one or more preselected patterns of information are found, copy certain preselected information associated with the one or more preselected patterns of information from the web page and store the preselected information in the data storage device.

Often times a previously functional URL becomes defective, that is, using the URL in a browser will not result in receipt of the desired web page. Such links are commonly known as broken links. Still further embodiments of the present invention relate to various methods of finding and fixing broken links.

A first such method relates to a method of detecting and fixing non-functioning uniform resource locators in a database having a plurality of uniform resource locators. The method includes (a) making an HTTP request using a selected one of the uniform resource locators; (b) determining whether an error message is received in response to the request; (c) if an error message is received, determining whether a web site identified by the selected uniform resource locator has been previously analyzed to obtain information relating to the structure of uniform resource locators associated with the web site; (d) if the web site has been previously analyzed, determining whether the web site is down; (e) if the web site is determined to not be down, manipulating said selected uniform resource locators based on the information relating to the structure of the uniform resource locators associated with the web site to form a manipulated uniform resource locator conforming to the structure; and (f) replacing in the database the selected uniform resource locator with the manipulated uniform resource locator. Steps (a) through (f) are repeated for a preselected group of the uniform resource locators, which may be all or less than all of the uniform resource locators stored in the database.

Another such method relates to a method of fixing a non-functioning uniform resource locator stored in a database wherein the non-functioning uniform resource locator is associated with a web site that has been analyzed to obtain information relating to the structure of uniform resource locators associated with the web site. According to the method, the non-functioning uniform resource locator is manipulated based on the information relating to the structure using at least one of information taken from the non-functioning uniform resource locator and information associated with the non-functioning uniform resource locator stored in the database to form a manipulated uniform resource locator conforming with the structure. The non-functioning uniform resource locator is replaced in the database with the manipulated uniform resource locator.

A still further method relates to a method of detecting and fixing non-functioning uniform resource locators in a database having a plurality of uniform resource locators. The method includes the steps of: (a) making an HTTP request using a selected one of the uniform resource locators; (b) determining whether an error message is received in response to the request; (c)if an error message is received, determining whether a web site identified by the selected uniform resource locator is down; (d) if the web site is determined to not be down, progressively creating one or more modified uniform resource locators, wherein a first modified uniform resource locator is created by removing a directory from the selected uniform resource locator and wherein each next modified uniform resource locator is created by removing a directory from a corresponding previous modified uniform resource locator; and (e) making, after each of the modified uniform resource locators is created, an HTTP request using the modified uniform resource locator and determining whether an error message is received in response to the request, wherein if an error message is not received, the creating step terminates and the selected uniform resource locator is replaced in the database by the modified uniform locator for which an error message was not received. Steps (a) through (e) are repeated for a preselected group of the uniform resource locators, which may be all or less than all of the uniform resource locators stored in the database.

Yet another such method relates to a method of fixing a non-functioning uniform resource locator stored in a database. According to this method, one or more modified uniform resource locators are progressively created, wherein a first modified uniform resource locator is created by removing a directory from the uniform resource locator and wherein each next modified uniform resource locator is created by removing a directory from a corresponding previous modified uniform resource locator. After each modified uniform resource locator is created, an http request is made using the modified uniform resource locator and a determination is made as to whether an error message is received in response to the request. If an error message is not received, the creating step terminates and the uniform resource locator is replaced in the database by the modified uniform resource locator for which an error message was not received.

### BRIEF DESCRIPTION OF THE DRAWINGS

Further features and advantages of the present invention will be apparent upon consideration of the following detailed description of the present invention, taken in conjunction with the following drawings, in which like reference characters refer to like parts, and in which:

FIG. 1 is a block diagram of an embodiment of a system combining browsing, buying and item registry functions according to the present invention;

FIG. 2 is an illustration of the list table and the item table utilized in an embodiment of the system shown in FIG. 1;

FIG. 3 is a front view of a client device forming part of the system shown in FIG. 1, wherein the client device is displaying a list window;

FIGS. 4, 5, 6 and 7 are flowcharts of various methods by which items and/or information can be added to a list maintained by the server system forming a part of the system shown in FIG. 1;

FIG. 8 is a block diagram of an alternate embodiment of a system combining browsing, buying, and item registry functions according to the present invention;

FIG. 9 is a flowchart of a method for finding and fixing broken links according to an aspect of the present invention; and

FIG. 10 is a flowchart of a method for ensuring that URLs stored by the server system forming a part of the system shown in FIG. 8 contain appropriate information for identifying the provider of the system shown in FIG. 8.

### DETAILED DESCRIPTION

The present invention addresses the limited scope of prior art organizational tools such as traditional gift registries across multiple dimensions. The present invention is a system for facilitating the capture, organization and fulfillment of people's wants, needs and desires comprising a universal electronic commerce platform and business processes that combine browsing, buying and item registry functions both online and offline.

The system is universal in at least three respects and thus provides maximum choice to consumers. First, unlike traditional gift registries, the system is not limited to a particular retailer or group of closely linked retailers. Second, because the system is not limited to a particular retailer or group of closely linked retailers, it is not limited to the particular items sold by that retailer or group of closely linked retailers. In fact, items may be listed using the system as merely a category in a non-branded, non-specific fashion, such as describing the item as a football or a camcorder, and can include things such as services, vacations, charitable contributions and even intangibles such as world peace. Finally, the system is not limited to use in connection with a particular occasion as is often the case with traditional gift registries, but instead is open to many forms of usage beyond a gift registry, such as for self purchase, creating a computerized shopping list, or for saving a link/pathway back to the current page in a web browser to be used to navigate back to that page at a later time, commonly known as bookmarking.

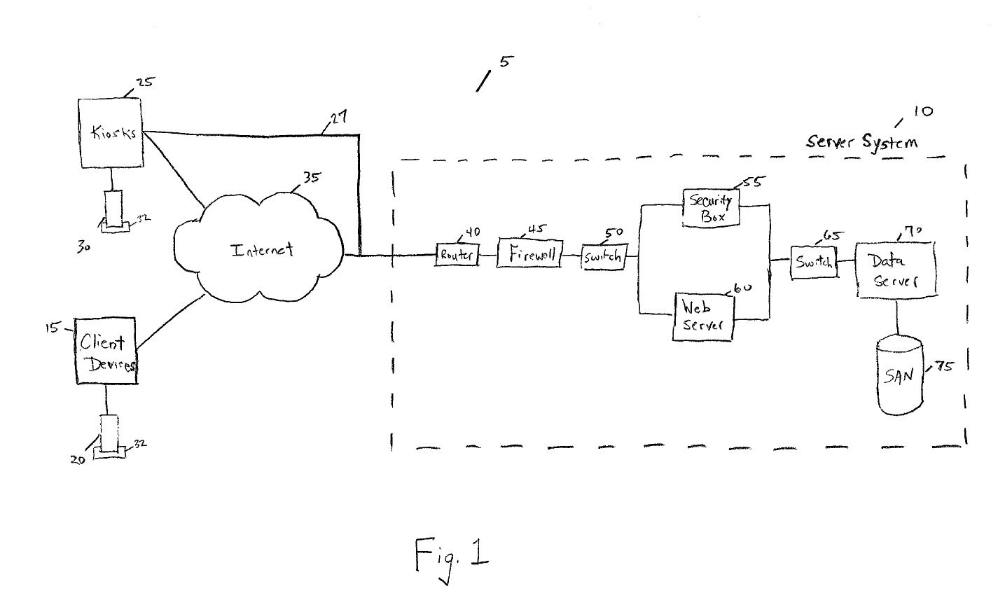

Referring to FIG. 1, a block diagram of a system 5 according to the present invention is shown. System 5 includes server system 10. Server system 10 includes a web site that is identified by a uniform resource locator (URL). Through the web site, a user is able to create and retrievably store a list that includes one or more items that he or she desires and, preferably, certain information relating to each of the items such as the selling price of the item, a description of the item, and the URL of a web site of a retailer that sells the item. As is known in the art, a web site commonly refers to one or more computers on the Internet running a server process which sends out web pages in response to requests such as Hypertext Transfer Protocol (HTTP) requests or Wireless Application Protocol (WAP) requests from remote computer systems. The remote computer systems run a special purpose application program, known as a browser, that effects the requesting of and displaying of web pages. An example of a browser is Internet Explorer developed and licensed by Microsoft Corporation of Redmond, Wash. As is also known in the art, a web page refers to a block or blocks of data available on the World-Wide Web comprising a file or files written in, for example, Hypertext Markup Language (HTML), Wireless Markup Language (WML), Dynamic Hypertext Markup Language (DHTML) or Extensible Markup Language (XML), and URLs are the form of address used on the World-Wide Web and provide a standard way of specifying the location of an object, typically a web page, on the Internet.

System 5 also includes one or more client devices 15 which have connectivity, either physical or wireless, to the Internet, indicated at reference numeral 35 in FIG. 1. Client devices preferably include a browser and a component for presenting information visually such a CRT or LCD screen. Using client devices 15, individuals can request web pages from the web site of server system 10 through the Internet 35. Each of the client devices 15 may, for example, comprise any one of a wired or wireless personal computer, a cellular telephone, a two way pager, or a personal digital assistant such as the wired Palm V or the wireless Palm VII sold by Palm, Inc. of Santa Clara, Calif.

A user can use a client device 15 to request web pages from the web site of server system that enable the user to create and retrievably store a list of items and related information, selectively view his or her list in its current state, or add items and information to or delete items and information from the list. A user can also use a client device 15 to purchase items by, for example, visiting an online retailer that maintains a web site accessible through the Internet 35. In addition, a third party, such as a potential gift giver, can use a client device 15 to request web pages from the web site of server system 10 that enable the third party to view any user's list. The third party may purchase items on the list by, for example, using a client device 15 to visit an online retailer or by visiting a traditional physical brick and mortar store.

According to an aspect of the present invention, a user may capture information relating to items of interest, that is, items he or she wants to add to his or her list maintained by server system 10, by visiting a traditional brick and mortar store and using bar code scanner 20 to scan the UPC or private bar code symbols of the items of interest. Bar code scanner 20 is adapted to store this information so that the user can later couple bar code scanner 20 to a client device 15 for the purpose of downloading the information to the client device 15. Once downloaded to the client device 15, the information can be transferred to server system 10 through the Internet 35 for inclusion in the user's list. The Bar code information is translated into information such as product name, price, etc. by consulting a database of information maintained by and/or accessible to server system 10. For example, the database of information may be maintained by server system 10 and comprise information obtained from particular stores or particular product manufacturers, or from data aggregators. Also, information may be obtained by consulting a third party that maintains a database of bar code information, such as BarPoint.com located in Ft. Lauderdale, Fla. whose information is accessible over the Internet. Bar code scanning technology is well known and thus will not be described in detail herein. A suitable example of bar code scanner 20 is the CS 2000 scanner sold by Symbol Technologies, Inc. of Holtsville, N.Y.

As seen in FIG. 1, system 5 also includes one or more kiosks 25. Kiosks 25 are preferably located in a traditional brick and mortar store that may or may not have a presence on the Internet and/or an offline traditional gift registry. In cases where the store already has a web site and/or an offline traditional gift registry, that store may want to enhance these options by adding the functionality of the system of the present invention. Kiosks 25 have connectivity to server system 10 which, as shown in FIG. 1, may be accomplished by having access to the Internet 35 or by a direct line connection shown at 27. In cases where connectivity to server system 10 is through the Internet 35, the kiosk 25 will be provided with a browser. Each kiosk 25 also has a component for presenting information visually, such as a CRT or an LCD, and a component for enabling the input of information, such as one or more of a keyboard, a mouse, and a touch screen. Also provided with each kiosk 25 is bar code scanner 30 that is similar to bar code scanner 20 and that may be coupled to the kiosk 25. As was the case with bar code scanner 20, a suitable example of bar code scanner 30 is the CS2000 scanner sold by Symbol Technologies, Inc. of Holtsville, N.Y. A user may use bar code scanner 30 to capture information relating to items of interest in the store associated with the kiosk 25 by scanning the UPC or private bar code symbols of the items. Bar code scanner 30 is adapted to store this information so that the user can later couple bar code scanner 30 to the kiosk 25 for the purpose of downloading the information to the kiosk 25.

Kiosk 25 further includes a data component that provides particular product information, such as selling price, product ID and a description that corresponds to the UPC and/or private bar code information collected by bar code scanner 30. This data component may be in the form of a local database stored on the hard drive of Kiosk 25. Alternatively, kiosk 25 may be connected to a separate network maintained by or for the particular traditional brick and mortar merchant in question in which the relevant product information is selectively retrievably stored in a database. As still a further alternative, the relevant product information of the particular traditional brick and mortar merchant in question may be selectively retrievably stored by server system 10 as part of a database maintained by the server system 10.

After a user has finished capturing information relating to items of interest in the store, the user couples bar code scanner 30 to kiosk 25. The information captured by bar code scanner 30 is transferred to kiosk 25 where, using the data component, it is translated into the corresponding product information. The corresponding product information is then presented to the user in a window on the visual component of the kiosk 25. The user may then review the information and decide whether they want to add the information to an existing list of theirs maintained by server system 10 or, in the case of new users, create a new list to be maintained by server system 10 and add the information to their new list. In either case, when the answer is yes, the information is transmitted to server system 10 through the Internet 35 or direct line 27, whichever the case may be, where it is saved as part of that user's list. In the case of an existing list, the user will need to be authenticated, such as through the use of a user ID and password, before new information can be added to the list.

Bar code scanner 20 may be coupled to client device 15 and bar code scanner 30 may be coupled to kiosk 25 by a physical connection such as an RS232 or USB type serial connection or a wireless connection such as RF or infrared. Alternatively, the coupling of bar code scanner 20 to client device 15 or bar code scanner 30 to kiosk 25 may be facilitated using cradle 32 into which bar code scanner 20 or bar code scanner 30 is placed. Cradle 32 is electrically coupled to and thus in communication with client device 15 or kiosk 25, whichever the case may be. In one embodiment, cradle 32 has a component that makes a physical electrical connection with bar code scanner 20 or 30, such as with electrical contacts provided on bar code scanner 20 or 30. Cradle 32 in this embodiment would then make either a physical connection with client device 15 or kiosk 25, such as with an RS232 or USB type serial connection, or a wireless connection with client device 15 or kiosk 25, wherein cradle 32 would have a wireless transmitter in communication with a wireless receiver of client device 15 or kiosk 25. In an alternative embodiment, bar code scanner 30 would have a wireless transmitter that communicates with a wireless receiver in cradle 32. Cradle 32 in this embodiment would then communicate with client device 15 or kiosk 25 by way of a physical connection such as those as described herein. As a further alternative, bar code scanner 20 or 30 may have a wireless transmitter that communicates with a wireless receiver in client device 15 or kiosk 25, in which case cradle 32 would serve as a convenient holding or docking station, perhaps for recharging a rechargeable battery contained therein, for bar code scanner 20 or 30 while information is being transmitted.

Referring again to FIG. 1, server system 10 includes router 40, the main function of which is to direct both incoming and outgoing data requests and/or data traffic. Connected to router 40 is firewall 45 that protects the remainder of server system 10 from unauthorized or malicious intrusions. Switch 50 is provided to direct data flow between firewall 45, security box 55 and web server 60. The main function of security box 55 is to provide log-in and authentication services for server system 10. In particular, once a user has created a list that is to be maintained by server system 10, the ability to access that list for purposes of adding information to, deleting information from or otherwise modifying the list is limited to that user by using user IDs and passwords. A suitable example of security box 55 is the VPN-1/Firewall-1 Security Suite sold by Check Point Software Technologies, Inc. of Grand Prairie, Tex. Web server 60 contains software for generating the web pages of server system 10, and runs a server process which sends out such web pages in response to requests from client devices 15 and kiosks 25. Web server 60 includes web pages having dynamic content based on stored data that it requests from data server 70, described below. A suitable example of web server 60 is the 220R Dual Processor sold by Sun Microsystems, Inc. of Palo Alto, Calif. running Windows NT or Windows 2000 and Internet Information Server sold by Microsoft Corporation of Redmond, Wash. Although only one security box 55 and one web server 60 are shown in FIG. 1, more than one of each device may be used depending on the needs of server system 10.

Server system 10 includes storage area network or SAN 75, which is a network storage device that acts as the central repository for data for server system 10. Preferably, SAN 75 comprises a relational database that stores all data gathered for each individual user, in particular the items and related information that make up each user's list. A suitable example of SAN 75 is the Symmetrix product sold by EMC² Corporation of Hopkinton, Mass. Although only one SAN 75 is shown in FIG. 1, it will be understood that multiple SANs 75 of various capacities could be used depending on the data storage needs of server system 10. Server system 10 also includes data server 70 which is coupled to SAN 75. A suitable example of data server 70 is the SQL server running on Windows NT sold by Microsoft Corporation of Redmond, Wash. The primary functions of data server 70 are that of providing access to the data stored in SAN 75 and populating SAN 75 with new data through requests made to data server 70. These functions are accomplished using appropriate structured query language or SQL requests and commands. Switch 65 is provided to direct data flow between security box 55, web server 60 and data server 70.

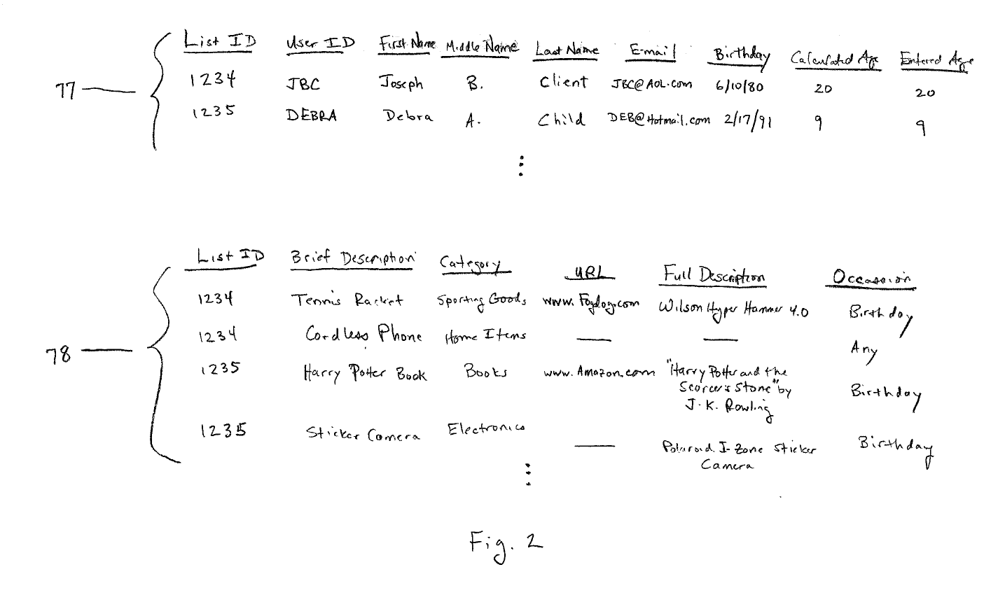

According to a preferred embodiment of the present invention, the relational database of SAN 75 includes two tables each comprising a number of records. As illustrated in FIG. 2, list table 77 includes one record for each of the lists created by each of the users. Each record of list table 77 comprises a plurality of fields including a list ID that is a unique numerical identifier for each user list, and the user's User ID, first, middle and last names, e-mail address, birthday, calculated age and entered age. As also illustrated in FIG. 2, item table 78 includes a separate record for each item of each user list. Each record of item table 78 comprises a plurality of fields including list ID, a brief description of the item, the item category as selected from a predetermined list of categories, a URL associated with the item which preferably identifies a web page of an online retailer selling the item, a full description of the item, and the occasion for which the user desires the item. As can be seen in FIG. 2, the relation between list table 77 and item table 78 is the list ID field.

In order to create a list to be maintained by server system 10, a user sends a request to create a list to web server 60 from either a client device 15 or a kiosk 25. When a client device 15 is used, the request will be communicated to web server 60 through Internet 35. When a kiosk 25 is used, the request will be communicated to web server 60 through Internet 35 or, if provided, through direct line 27. In a preferred embodiment, creation of a list starts with a user requesting a certain web page known as the home web page from web server 60 using the appropriate URL. The home web page includes a hyperlink that, upon activation, sends a request to create a list to web server 60. In response to the request, web server 60 transmits back to the client device 15 or the kiosk 25, whichever the case may be, a web page preferably comprising a form to be completed by the user. The form requests from the user certain information, including certain personal information about the user and a desired user ID and password. After the user completes and submits the form, web server 60 accesses the data stored in SAN 75 to determine whether the desired user ID is available. If not, web server 60 transmits a web page to the client device 15 or the kiosk 25, whichever the case may be, including an explanation and a request that the user choose another user ID. If the user ID is available, a list is created for the user, which preferably means that a record for that user containing the provided information is created in list table 77 of the relational database of SAN 75.

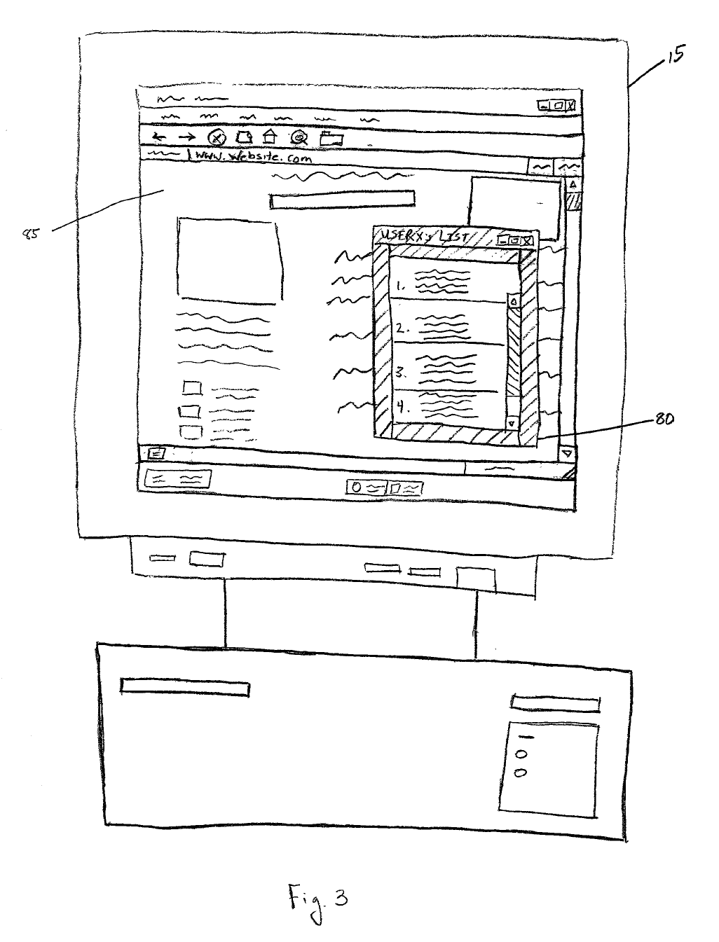

A user's list, when accessed through server system 10 either by the user for purposes of adding items and/or information to or deleting items and/or information from the list or by a third party for purposes of viewing the list, is presented to the user or the third party in the form of a window. In particular, when web server 60 receives an appropriate request from a client device 15 or a kiosk 25 for a list maintained by server system 10, it accesses all of the relevant information from SAN 75, that is all of the information in the records of item table 78 associated with the user, by sending a request to data server 70, which in turn sends an SQL request to SAN 75. Web server 60 then causes a new window that contains the user's list, that is, all of the items and related information that have been stored by the user, to open on the display component of either the client device 15 or the kiosk 25. The window may manifest itself in the form of a web browser window, a window generated by an application installed on the client device 15 or the Kiosk 25, or a window generated by an applet embedded in a document sent from server system 10. An example of such a new window, referred to herein as list window 80, displayed on the screen of a personal computer type client device 15 is shown in FIG. 3. As can be seen in FIG. 3, list window 80 initially resides in the foreground of the screen of client device 15 which means that it is the active window, while window 85 that displays the contents of a web page being viewed by the user of client device 15 resides in the background. List window 80 obscures a portion of window 85. As is known in the art, it is possible to switch list window 80 to the background and window 85 to the foreground, in which case list window 80 would be completely obscured by window 85.

In the case of a third party that wants to view a user's list, perhaps for the purpose of buying a gift for the user, the third party can access and view, but not modify, the user's list by sending a request to view the user's list to web server 60. Preferably, a third party may send a request to view the user's list to web server 60 by activating, using either a client device 15 or a kiosk 25, a hyperlink included in the home page of server system 10. Activating the hyperlink will cause web server 60 to transmit to the client device 15 or the kiosk 25 a web page comprising a form requesting various information that may help to identify the user's list, such as the user's name, user ID, and/or address. After the user completes and submits the form, web server 60 accesses the relevant data stored in SAN 75 and returns to the client device 15 or the kiosk 25 a web page including a listing of one or more user lists that satisfy the submitted criteria. The third party is then able to choose the appropriate list for viewing and send a request to view that list to web server 60 using a hyperlink provided in the web page containing the listing. In response to this request, web server 60 accesses the relevant data stored in SAN 75 and causes list window 80 for the list selected by the third party to be displayed on the client device 15 or the kiosk 25.

In the case of a user that wants to add items and/or information to or delete items and/or information from his or her pre-existing list, that user must first be authenticated. A user is authenticated by transmitting to web server 60 a user ID and a matching password. Once authenticated list window 80 is opened in edit mode and may be used to send a request to modify, add or delete an item to web server 60. Items and/or information can be added to a list in several ways. First, information can be added using either client device 15 or Kiosk 25 through scanning Bar code information in the manner described above. Alternatively, a user can simply enter data manually into appropriate places of list window 80 using the input devices associated with a client device 15 such as a keyboard, a touch screen and/or a mouse. Once a user has entered all of the data relating to the items and/or information to be added to his or her list into list window 80, the user transmits a request to add the items and/or information to the list to web server 60, for example by activating a hyperlink or a button provided in list window 80. In response, web server 60 sends a signal to data server 70 to store the data in SAN 75. Preferably, data server 70 generates an appropriate SQL request to store the data relating to the items and/or information to be added to the user's list in the appropriate place in item table 78, which may require creating a new record in item table 78 or modifying an existing record in item table 78. Thus, the next time that the user's list is accessed, whether it be by the user or a third party, the list window 80 will display the list with the new items and/or information. It will be apparent to one of skill in the art that items and/or information can be deleted from a list in a similar manner.

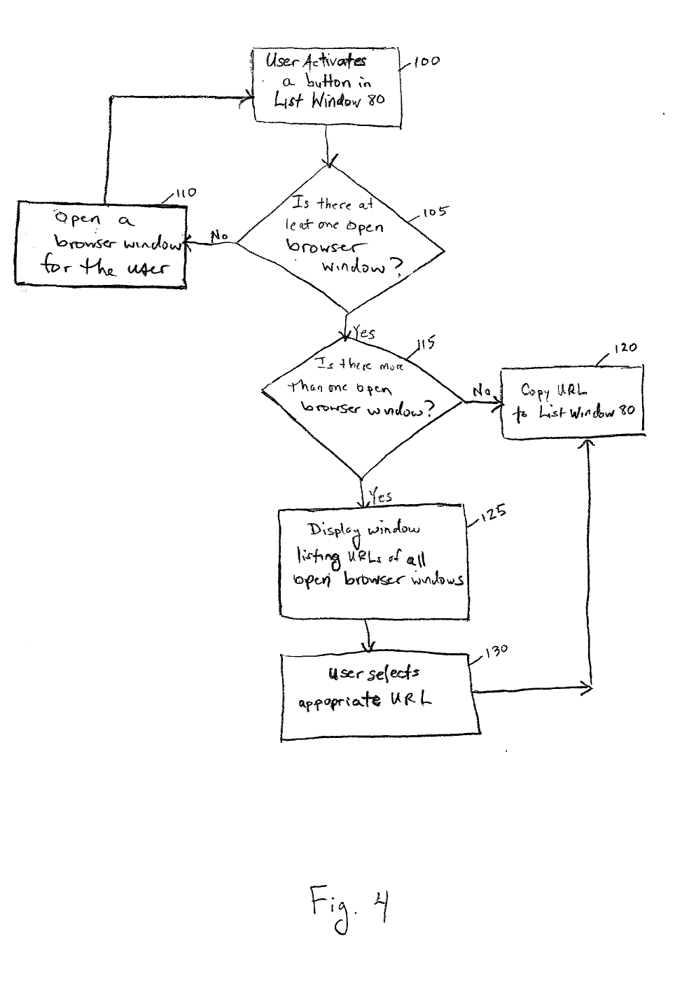

FIG. 4 is a flowchart of an alternative method by which information can be added to a user's list. System 5 of the present invention permits a user to use a client device 15 to “surf” the Internet, that is, request and view web pages from various web sites on the Internet using appropriate URLs, while list window 80 displaying the user's list remains open. The method shown in FIG. 4 enables the user to capture and add to his or her list the URL of a web page that is open on client device 15 that shows or contains an item the user desires to add to his or her list. The software code required to perform the method shown in FIG. 4 may be provided in list window 80 incorporating a client component loaded onto the client device 15 as a dynamically linked library (DLL) the first time list window 80 is opened.

As shown in box 100 of FIG. 4, when a user has found a web page containing an item he or she wants to add to his or her list, and the user wants to capture the URL of that web page, the user must activate the functionality, for example, by activating a button provided in list window 80. Next, referring to box 105, a determination is made as to whether there is at least one open browser window other than list window 80 in the client device 15 that the user is using to add information to his or her list. If it is determined that there is not at least one open browser window, then, as shown in box 110, a browser window is opened for the user on the client device 15 so that the user can search the Internet. As shown in FIG. 4, nothing more is done until the user again activates the functionality. If, however, it is determined that there is at least one open browser window, then, as shown in box 115, a determination is made as to whether there is more than one open browser window. If there is not more than one open browser window, i.e., there is only one open browser window, then, as shown in box 120, the URL of the open browser window is copied to the appropriate part of list window 80. If, on the other hand, it is determined that there is more than one open browser window, then, as shown in box 125, a window is opened in the client device 15 displaying to the user a listing of the URLs of all of the open browser windows. The user is asked to select one open browser window, and in particular, the open browser window showing or containing the item to be added to the list. Next, the user selects the appropriate desired URL as shown in box 130 and the URL is copied from the browser's object model to the appropriate part of list window 80. After the URL of the open browser window showing or containing the item to be added to the list is copied to the appropriate part of list window 80, the user can then manually add additional information to the appropriate parts of list window 80, such as item description and price. When the user has finished entering information into list window 80, the user transmits a request to web server 60, for example by activating a hyperlink or a button provided in list window 80, to add the items and/or information contained in list window 80 to the user's list. Upon receiving the request, the web server 60 causes the data to be saved in SAN 75 through data server 70 as a new record in item table 78, thus becoming part of the user's list. The software code necessary to implement the method shown in FIG. 4 could, without undue experimentation, be written by one of ordinary skill of the art and thus will not be described in detail herein.

It is known in the art that web pages of web sites on the Internet are often written and organized according to a particular template such that certain information is always located in a particular location within the page layout design of the web page. As a result, the web pages of the web site have a consistent internal structure. For example, the web pages of an online retailer that show particular products of that retailer may each be written and organized according to a template in which the name of the retailer, and the price and description of the products are located in a particular place within each web page. Writing and organizing web pages according to uniform templates in this manner makes it relatively easy to edit the information contained in the web pages, even for individuals not familiar with the web pages, which is particularly important for online retailers whose information changes often.

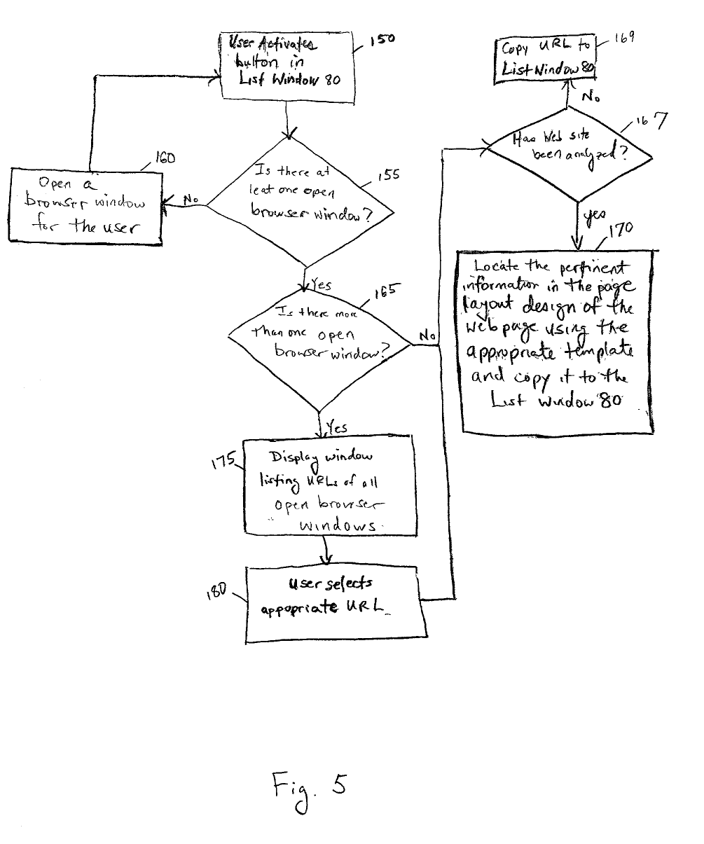

FIG. 5 is a flowchart of a further alternative method by which information can be added to a user's list. The method shown in FIG. 5 is intended to be used in connection with the web pages of web sites for which a study or analysis as described above has been previously conducted to determine the template of the page layout design of the web pages of those web sites. Once knowledge of the template of the page layout design of the web pages of a web site is obtained, software may be extended to search the page layout design of the web pages to locate and copy certain specified information. The method shown in FIG. 5 utilizes such software to enable the user to capture and add to his or her list information such as the name of the online merchant selling the item, the price of the item, the description of the item provided on the web page, and any other predetermined specified information from the web page. As described in connection with FIG. 4, the URL of the web page may be copied from web browser's object model. As was the case with the method shown in FIG. 4, the software code required to perform the method shown in FIG. 5 may be provided in list window 80 incorporating a client component loaded onto the client device 15 as a dynamically linked library (DLL) the first time list window 80 is opened.

As shown in box 150 of FIG. 5, when a user has found a web page containing an item he or she wants to add to his or her list, and the user wants to capture certain pertinent information from the web page, the user must activate the functionality, for example by activating a button provided in list window 80. Next, referring to box 155, a determination is made as to whether there is at least one open browser window other than list window 80 in the client device 15 that the user is using to add information to his or her list. If it is determined that there is not at least one open browser window, then, as shown in box 160, a browser window is opened for the user on the client device 15 so that the user can search the Internet. Nothing more is done until the user again activates the functionality. If, however, it is determined that there is at least one open browser window, then, as shown in box 165, a determination is made as to whether there is more than one open browser window. If there is not more than one open browser window, i.e., there is only one open browser window, then referring to box 167, the URL of the open browser window is copied from the browser object model and sent to server system 10 where it is compared to a list of web sites for which the page layout design of the web pages has been analyzed. If the web page is not from a previously analyzed web site, then as a default, the URL of the web page is copied to list window 80 as shown in box 169. If, however, the web page is from a previously analyzed web site, then, as shown in box 170, the desired information, such as, for example, the name of the online merchant selling the item, the price of the item, and the description of the item provided on the web page, is quickly located within the page layout design of the open browser window based on the appropriate template of the corresponding online merchant. Once located, the pertinent information is copied to the appropriate part of list window 80. Also, the URL of the web page is copied to list window 80 from the web browser's object model. If, on the other hand, it is determined that there is more than one open browser window, then, as shown in box 175, a window is opened in the client device 15 displaying to the user a listing of the URLs of all of the open browser windows. The user is asked to select one linked window or open browser window, in particular, the open browser window showing or containing the item to be added to the list. Next, the user selects the appropriate desired URL as shown in box 180 and the method proceeds to the steps described above with respect to boxes 167, 169 and 170. After the steps shown in FIG. 5 are completed, the user may then manually add additional information to the appropriate parts of list window 80. When the user has finished entering information into list window 80, the user transmits a request to web server 60, for example by activating a button provided in list window 80, to add the items and/or information contained in list window 80 to the user's list. Upon receiving the request, the web server 60 causes the data to be saved through web server 70 in SAN 75 as a new record in item table 78, thus becoming part of the user's list. The software code necessary to implement the method shown in FIG. 5 could, without undue experimentation, be written by one of ordinary skill of the art and thus will not be described in detail herein. It will be understood that specific code will need to be written for each web site for which the web page template has been analyzed based on the particulars of that template.

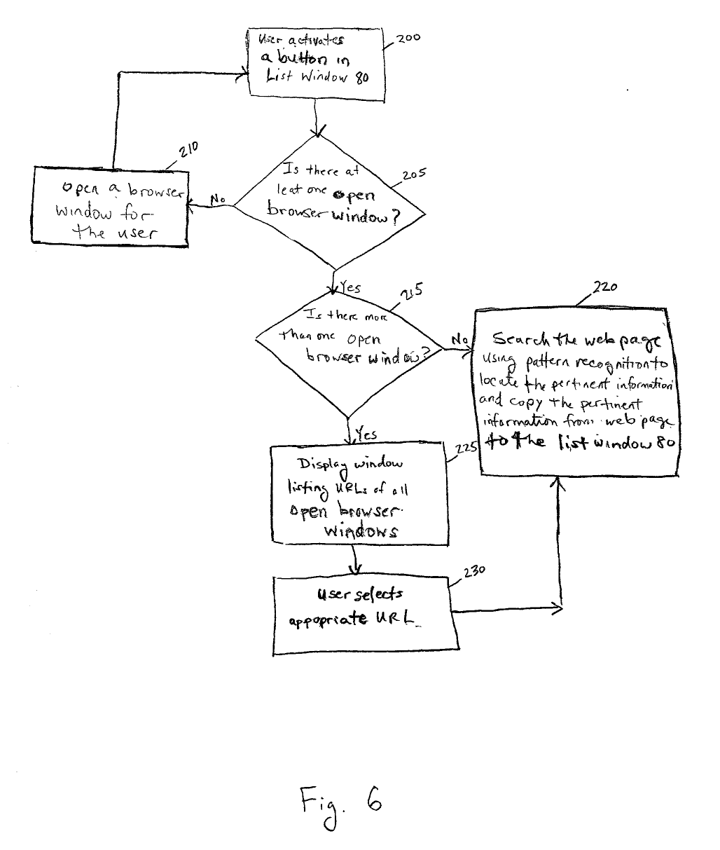

The method shown in FIG. 5, which is intended to be used in connection with the web pages of previously analyzed web sites, is useful for system 5 because it is likely that a relatively small number of web sites will account for a large proportion of the items that users want to add to their lists. Thus, code implementing the method shown in FIG. 5 can be written for those web sites, providing the users a convenient tool with which to add items and/or information to their lists maintained by server system 10. There will remain, however, a very large number of web sites that have not been analyzed for which such code will not be written. FIG. 6 is a flowchart of a method by which information from a web page of a web site relating to an item a user wants to add to his or her list, such as a product ID comprising a manufacturer number or retailer product identification number, a description of the item, and the price of the item, can be added that user's list regardless of whether the web site has been previously analyzed.

As shown in box 200 of FIG. 6, when a user has found a web page containing an item he or she wants to add to his or her list, and the user wants to capture certain pertinent information from the web page, the user must activate the functionality by activating a button provided in list window 80. Next, referring to box 205, a determination is made as to whether there is at least one open browser window in the client device 15 that the user is using to add information to his or her list. If it is determined that there is not at least one open browser window, then, as shown in box 210, a browser window, is opened for the user on the client device 15 so that the user can search the Internet. Nothing more is done until the user again activates the functionality. If, however, it is determined that there is at least one open browser window, then, as shown in box 215, a determination is made as to whether there is more than one open browser window. If there is not more than one open browser window, i.e., there is only one linked window or open browser window, then, as shown in box 220, the page layout design of the open browser window is searched to locate the desired information. However, rather than relying on a template as in the method shown in FIG. 5, pattern recognition is used to locate certain pertinent information in the page layout design of the web page in question. For example, it may be assumed that the text following a dollar sign appearing in the web page is the price of the item and the text appearing on the center portion of the web page is the description of the item. Also, it is known that LTRLs generally have an address portion that appears to the left of a “?” symbol. The portion of a URL appearing to the right of the“?” symbol generally consists of one or more field/variable names and an associated data value. The field/variable names can be examined, and, if a term such as “prod,” “product,” “product ID,” “ID” or the like is found, it can be assumed that the associated data value is the product ID. It may also be assumed that text appearing in proximity with the product ID on the web page is the description of the item. Once located in the page layout design and/or URL using one or more of these pattern recognition techniques, the pertinent information is copied to the appropriate part of list window 80. If, on the other hand, it is determined that there is more than one open browser window, then, as shown in box 225, a window is opened in the client device 15 displaying to the user a listing of the URLs of all of the open browser windows. The user is asked to select one open browser window, and in particular, the open browser window showing or containing the item to be added to the user's list. Next, the user selects the appropriate desired URL as shown in box 230 and the selected open browser window is searched using pattern recognition as described above to locate the desired pertinent information. Once located, the pertinent information is copied to the appropriate part of list window 80. After this step, the user may then manually add additional information to the appropriate parts of list window 80. When the user has finished entering information into list window 80, the user transmits a request to web server 60, for example by activating a button provided in list window 80, to add the items and/or information to the list. The data is then saved in SAN 75 through data server 70, and thus becomes part of the user's list. The software code necessary to implement the method shown in FIG. 6 could, without undue experimentation, be written by one of ordinary skill of the art and thus will not be described in detail herein. As was the case with the method shown in FIGS. 4 and 5, the software code required to perform the method shown in FIG. 6 may be provided in list window 80 incorporating a client component loaded onto the client device 15 as a dynamically linked library (DLL) the first time list window 80 is opened.

In the embodiments of the present invention shown and described in connection with FIGS. 5 and 6, the software has been described as being stored locally at client device 15. Thus, in the event that the software is modified, new versions of the software will need to be downloaded to each client device 15. In the case of the method shown in FIG. 5, the software would need to be modified each time the web site of an online merchant that has not previously been analyzed is analyzed to determine the template of its web pages, which may be fairly frequently. Thus, according to an alternate embodiment of the present invention, the need to download modified software to the many client devices 15 is eliminated by performing the functions of either or both of the methods shown in FIGS. 5 and 6 at server system 10. Because the software is maintained at server system 10 in this embodiment, when the software is modified, it need only be modified in a single place.

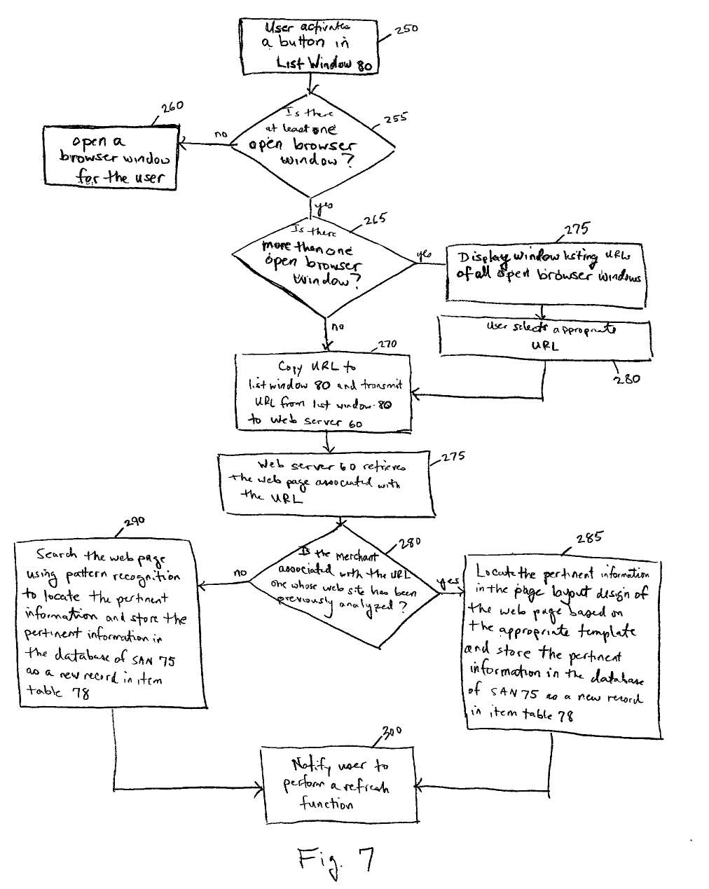

FIG. 7 is a flowchart of a method by which information may be added to a user's list wherein the implementing software is stored at server system 10. The method shown in FIG. 7 incorporates functionality shown and described in connection with the methods of FIGS. 4, 5 and 6. Referring to box 250 of FIG. 7, when a user has found a web page containing an item he or she wants to add to his or her list, and the user wants to capture certain pertinent information from the web page, the user must activate a button provided in list window 80. Next, referring to box 255, a determination is made as to whether there is at least one open browser window in the client device 15 that the user is using to add information to his or her list. If it is determined that there is not at least one open browser window, then, as shown in box 260, a browser window is opened for the user on the client device 15 so that the user can search the Internet. As shown in FIG. 7, nothing more is done until the user again activates the functionality. If, however, it is determined that there is at least one open browser window, then, as shown in box 265, a determination is made as to whether there is more than one open browser window. If there is not more than one open browser window, i.e., there is only one open browser window, then, as shown in box 270, the URL of the open browser window is copied to the appropriate part of list window 80 from the browser's object model and then transferred automatically to web server 60 through the Internet 35 shown in FIG. 1. If, on the other hand, it is determined that there is more than one browser window, then, as shown in box 275, a window is opened in the client device 15 displaying to the user a listing of the URLs of all of the open browser windows. The user is asked to select one open browser window, and in particular, the open browser window showing or containing the item to be added to the user's list. Next, as shown in box 280, the user selects the appropriate desired URL and the URL is copied to the appropriate part of list window 80 from the browser's object model and then automatically transferred to web server 60 through the Internet 35 shown in FIG. 1. The software that performs this functionality may be in the form of a java applet or a DLL loaded onto the client device 15.

Referring to box 275, when the URL of the linked window or open browser window showing or containing the item to be added to the list is received by web server 60, web server 60 retrieves through the Internet 35 the web page associated with the URL. Next, as shown in box 280, a determination is made in the manner described above with respect to FIG. 5 as to whether the merchant associated with the URL is one whose web site has been previously analyzed to determine the template of the web pages of the web site. If it is determined that the merchant associated with the URL is one whose web site has been previously analyzed, then, as shown in box 285, the pertinent information such as a description of the item, the price of the item, and the product ID is quickly located in the page layout design of the web page based on the template associated with the merchant. Once located, the pertinent information is copied and is stored, along with the URL, in the database of SAN 75 through data server 70 as a new record associated with the user in item table 78. If, however, it is determined that the merchant associated with the URL is not one whose web site has been previously analyzed, then, as shown in box 290, the web page is searched using pattern recognition as described above in connection with FIG. 6 to locate the pertinent information such as a description of the item, the price of the item, and a product ID. Once located, the pertinent information is copied and is stored, along with the URL, in the database of SAN 75 through data server 70 as a new record associated with the user in item table 78.

Referring to box 300, after the pertinent information has been stored in the database of data server 70 on SAN 75, whether it be as described in connection with box 285 or box 290, a dialog box open on the client device 15 requesting the user to perform a refresh function. Performing a refresh function will cause web server 60 to create and transmit to the client device a new list window 80 that is updated to include the recently added item and associated 15 information. The software required to implement the method shown in FIG. 7 in boxes 275 through 300 is preferably stored on SAN 75, a single location. Thus, in the event that any changes need to be made to the software, such as to modify the software to enable it to handle the template of a newly analyzed vendor, those changes can be made in a single place.

When a user adds items and information to his or her list while using a browser to view web pages on the Internet, such as by any one of the methods shown in FIGS. 4 through 7, that user must continually switch between their browser and an open list window 80 containing their list. For example, if a user is viewing a web page using a browser that contains an item he or she would like to add to their list, the user must make the list window 80 containing their list the active window on the screen of their client device 15 so that the user can either manually input information into the list window 80 or activate one of the methods shown in FIGS. 4 through 7. As is known in the art, when the browser window is the active window, list window 80 will often become partially or completely obstructed. Many people are not aware that with the Windows operating system sold by Microsoft Corporation of Redmond, Wash., the most popular operating system in use today and most likely the operating system that will be used by most client devices 15, an obstructed window can be brought to the foreground, i.e., made the active window, by using a button on the toolbar at the bottom of the screen. Similar tools, the existence of which many people are not aware, are available in other operating systems for bringing obstructed windows to the foreground. As a result, many people think that completely obstructed windows are lost and they do not know how to bring them to the foreground again.

According to an aspect of the present invention, a small icon may be provided on the screen of each client device 15 whenever a list window 80 is open but is obstructed by another window, such as a browser window. The icon will always be visible to the user when the window containing the list window 80 is obstructed, and may, for example, be positioned in the upper right hand corner of the screen of the client device 15. As is known in the art, icons may be created using java applet programs, and in the present invention, such an icon could be created by a java applet program that is transmitted to the client device 15 as an attachment to list window 80. Furthermore, the icon may be configured such that when a user uses a mouse to click on the icon, the obstructed list window 80 is made the active window and is brought to the foreground of the screen of the client device 15. The user may then either enter information manually into list window 80 or activate one of the methods of FIGS. 4 through 7 in list window 80. Alternatively, the icon may be configured such that when a user uses a mouse to click on the icon, the list window 80 is brought to the foreground and a pre-selected one of the processes shown in FIGS. 4 through 7 is automatically initiated. When the list window 80 is either closed or is no longer obstructed by other windows, the icon may be configured to automatically close depending on the preferences of the user. Because the icon is generated by a java applet program that is an attachment to list window 80, this functionality is available to the user without any user-installed software. The actual java code required to implement an icon as described herein can be written, without undue experimentation, by one of ordinary skill in the art and thus will not be discussed herein.

Most windows based operating systems in use today support a drag and drop functionality by which a mouse can be used to highlight or capture text and/or images in a first open window and move copies of the text and/or images to a different open window. Often, this functionality is a shortcut form of a copy and paste function. According to a further aspect of the present invention, a user may use this drag and drop functionality to add items and/or information to his or her list. Specifically, a user can drag text, an image, or both relating to an item of interest from a web page or another source available to client device 15 and drop the text and/or image in list window 80. As a result, the text and/or images will be copied to the appropriate place in list window 80. In particular, the text from the drag and drop is analyzed and processed to extract information such as price and description as indentified by a $ symbol and location on the page in question. Also, the associated web site can be extracted from the source document domain name. The user may then manually add any additional desired information to the appropriate parts of list window 80. Once the user has entered all of the information to be added to his or her list into list window 80, the user transmits a request to add the items and/or information to the list to web server 60, for example by activating a button provided in list window 80. The data is then saved in SAN 75 through data server 70, and thus becomes part of the user's list. Furthermore, the icon described above may be configured such that when text and/or images are dragged and dropped on the icon, the list window 80 is brought to the foreground and the test and/or images are automatically copied to the appropriate place in the list window 80.

Often, a previously functional URL becomes defective, that is, using the URL in a browser will not result in receipt of the desired web page. Such links are commonly known as broken links. Broken links are most often caused by URLs that need system level variables, or by redesign of the corresponding web site. In system 5, the list windows 80 often include the URLs of online retailers that sell the items on a user's list in the form of hyperlinks. These hyperlinks enable people to quickly obtain information related to and possibly purchase the items on the list. Thus, if the URL of a hyperlink provided in the list windows 80 becomes a broken link, potential purchasers may find it difficult or impossible to obtain information related to or purchase the item corresponding to the broken link.

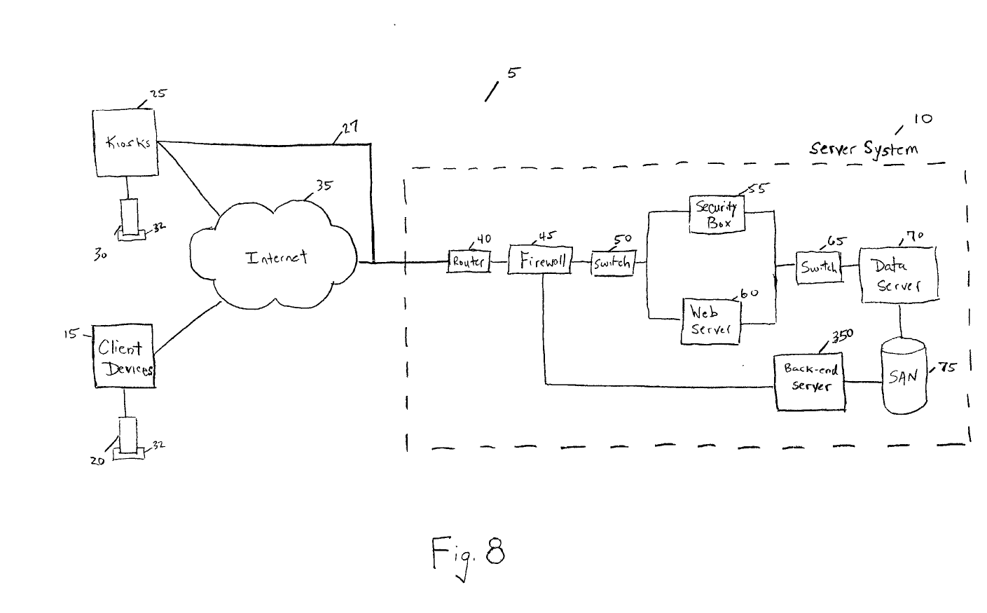

FIG. 8 is a block diagram of an alternate embodiment of the present invention in which system 5 is provided with back-end server 350, which may be of the same type as data server 70, coupled to SAN 75. Back end server 350 includes a data scrubbing engine, comprising software loaded on backend server 350, adapted to find and fix broken links that form a part of the records of item table 78 stored in the database of data server 70. The data scrubbing engine may be set to periodically traverse through all of the records of item table 78, test each URL contained therein to determine whether it is a broken link, and try to fix each broken link that is found. Alternatively, the data scrubbing engine may be adapted to traverse through all of the records of item table 78, test only particular URLs containing particular domains known to be problematic, and try to fix each broken link that is found. As still a further alternative, the data scrubbing engine may be adapted to test URLs only when web server 60 generates a list window 80 associated with a particular user for transmission to a client device 15, in which case only the URLs of the records of item table 78 associated with that user will be tested and, if necessary, fixed.

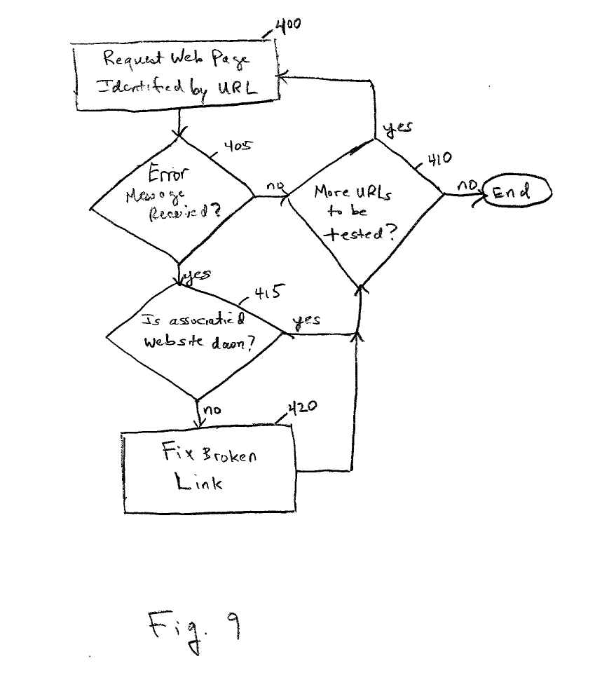

Referring to FIG. 9, a method of finding and fixing broken links that may be utilized with any one of the three alternatives described above is shown. As shown in box 400, the data scrubbing engine 350 requests through the Internet 35, using an HTTP request, the web page identified by the URL in question. As seen in FIG. 8, back-end server 350 is connected to firewall 45 and thus has access to the Internet 35. Next, as shown in box 405, a determination is made as to whether an error message, such as page not found, improper request or time out error has been received in response to the request. If an error message is not received, i.e., the requested web page was received, then the URL is not a broken link, and, as shown in box 410, a check is made as to whether any more URLs need to be tested, that is, whether the data scrubbing engine has traversed through all of the appropriate records in item table 78. If no more URLs need to be tested, then the process ends. If, however, there are URLs remaining that need to be tested, then the process returns to box 400. Referring again to box 405, if an error message is received, then, as shown in box 415, the data scrubbing engine checks to see if the error message is a time out error, meaning that nothing is responding to the request sent by the data scrubbing engine 350. If so, that means that web site associated with the URL is down. If the web site is merely down, then the process returns to box 410. If the associated web site is not down, then that means that the URL is a broken link. As shown in box 420, the data scrubbing engine tries to fix the broken link.

According to a first alternative, a number of web sites will be analyzed to obtain information relating to the structure of URLs associated with the web sites. For example, it may be learned by analyzing a web site that URLs associated therewith must be formatted in a certain way, such as by using a particular identifier, or that the web site employs session level dependencies. The data scrubbing engine may try to fix a broken link known to be associated with a particular previously analyzed web site by manipulating the URL based on the knowledge and information obtained by previously analyzing the web site, a manual process, which information is stored in SAN 75, using information from the URL, or using information from the record of item table 78 from which the URL was taken. For example, for a web site that employs session level dependencies, the URL that is stored in SAN 75 may have been valid at the time it was originally stored, but will later be invalid because the session has ended. In the simplest case, the URL would be set to the domain to return a user to a home page. In some cases, an ID in the URL may be used on a special page provided by the designer of the web site to find the item. The URL that has been determined to be a broken link is then replaced in the record of item table 78 with the manipulated URL. As was the case with the method shown in FIG. 5, particular software will be written for each analyzed web site.

As a second alternative, the data scrubbing engine may try to fix the broken link by stepping through the URL and progressively taking away levels of directories, one at a time. At each step, the data scrubbing engine sends out an HTTP request based on the modified URL. If an error message is received, the progression continues. If an error message is not received, but rather a web page is received, then that modified version of the URL is stored in place of the original URL in the record of item table 78. If a domain is reached during this progressive process without finding a functioning URL, then the broken URL is replaced with the modified URL as it exists when the domain is reached. For example, if the URL http ://www.retailer.com/category/index.jsp?entryId+9 1925&category path=6220 is determined to be a broken link, then the data scrubbing engine would take away the right most directory and would send out a request using http://www.retailer.com/category. If an error was not returned, then that URL would be used to replace the original URL. If, however, an error was received, then another directory, the “category” directory, would be taken away. However, because doing so would result in the .com domain being reached, then the URL http://www.retailer.com would be used to replace the original URL.

After the broken link has been fixed, the process returns to box 410 to determine whether there are any more URLs to test. The specific software code required to implement the process shown in FIG. 9 is within the ordinary skill of the art and thus will not be described in detail herein.

Through use of system 5, in particular through use of the lists maintained by server system 10 of system 5, individual consumers' desires to own things, whether by receiving them as a gift or by self-purchase, are captured at the point of inception. For example, an individual's desire to own an item may be captured when the individual uses a client device 15 to shop online, that is view the web pages of the web sites of various online merchants, and then to add the item and related information to either a new or existing list. As another example, an individual's desire to own an item may be captured when the individual shops in a store having a kiosk 25, and then uses kiosk 25 to add the item and related information, captured using scanner 30, to either a new or existing list. As still another example, an individual's desire to own an item may be captured when the individual shops in a store and uses a wireless client device 15 such as a cellular phone to add an item to a new or existing list.

Furthermore, the point of origination of a desire for an item can be recorded at the time the item is added to an individual's list by, for example, keeping track of the web site from which an item is added to a list, keeping track of the kiosk 25 and thus the store from which an item is added to a list, or keeping track of the store in which the individual formed a desire for an item by having the individual indicate that store when adding the item to his or her last by any of the methods described herein. Also, the point of ultimate purchase of the item can be recorded. For example, if an item is purchased online by using a link provided in an individual's list, that online retailer can be made aware that the purchase was made as a result of the item appearing in a list and can record that fact by ensuring that the link used by the purchaser is formatted to include a unique identifier identifying the system provider. Also, if someone purchases an item offline at a traditional brick and mortar store, that person may indicate the place of purchase when viewing the individual's list and marking an item as fulfilled (so that a subsequent purchaser will not purchase the same item). By tracking an item from the point of origin of the desire to have the item to the point of its ultimate purchase, system 5 allows for the splitting of the economic value of originally enticing individual consumers to desire an item from the economic value of enticing or enabling them or others to purchase that item. At least two scenarios for splitting the economic value of originally enticing individual consumers to desire an item from the economic value of enticing or enabling them or others to purchase that item through use of system 5 are possible. In each case, it is contemplated that certain retailers have agreed to become affiliated with the provider of system 5 and have agreed to pay certain fees for sales that have a connection to the use of system 5.

In the first scenario, an individual consumer adds an item to his or her list due to the activities of retailer X, an affiliate of the provider of system 5, that brought the individual to retailer X's physical or online store, presented the individual with merchandise and enticed him or her to desire it and ultimately add it to his or her list maintained by server system 10. The individual consumer or a third party subsequently purchases the item from the same retailer X, either online at a web site maintained by retailer X or offline at retailer X's physical store. Retailer X retains the enticement and purchase economic value of the transaction, and remits to the provider of system 5 a fee for the value of its role as an enabling intermediary. In the case where the item was purchased online using a link having a unique identifier embedded therein, the affiliated retailer will know that it owes a fee to the provider of system 5 for the purchase. In the case where the purchase is made offline and the purchaser indicates the place of purchase in the list in question, the provider of the system 5 will need to make the affiliated retailer aware that it owes a fee for the purchase. The precise value of the fee remitted to the provider of system 5 must be negotiated between the parties.

In the second scenario, an individual consumer adds an item to his or her list due to the activities of retailer X, an affiliate of the provider of system 5, that brought the individual to retailer X's physical or online store, presented the individual with merchandise and enticed him or her to desire it and ultimately add it to his or her list maintained by server system 10. The individual consumer or a third party subsequently purchases the item from a different retailer Y, an affiliate of the provider of system 5, either online at a web site maintained by retailer Y or offline at retailer Y's physical store. Retailer Y retains the purchase economic value of the transaction, and remits to retailer X a fee for the enticement value of the transaction and to the provider system 5 a fee for the value of its role as an enabling intermediary. This scenario presents a situation whereby two or more companies that normally compete with one another cooperate in a specific venue while still competing in others. In this scenario, it is contemplated that the provider of system 5 will act as an intermediary that collects information and serves as a clearinghouse for the sharing of revenue. The precise value of the fees remitted to retailer X and the provider of system 5 must be negotiated among the parties.

As just described, certain retailers may choose to become affiliated with the provider of system 5 and agree to pay to the provider of system 5 a fee for each sale that results from the purchaser viewing a list maintained by server system 10 and using the affiliated retailer's URL provided in the list to purchase an item. The provider of system 5 will be able to be linked to such sales by the affiliated retailer as long as the URL has an affiliate identification as a part thereof. According to an aspect of the present invention, the data scrubbing engine of back-end server 350 may be adapted to periodically traverse through all of the records of item table 78 to ensure that each of the URLs stored as part of the records of item table 78 is properly formatted to include an affiliate identification if appropriate so that the provider of system 5 will be able to be identified and linked to online sales that are made by a retailer affiliated with the provider of system 5 and that resulted from the purchaser viewing a list maintained by server system 10 and using a URL provided in the list.

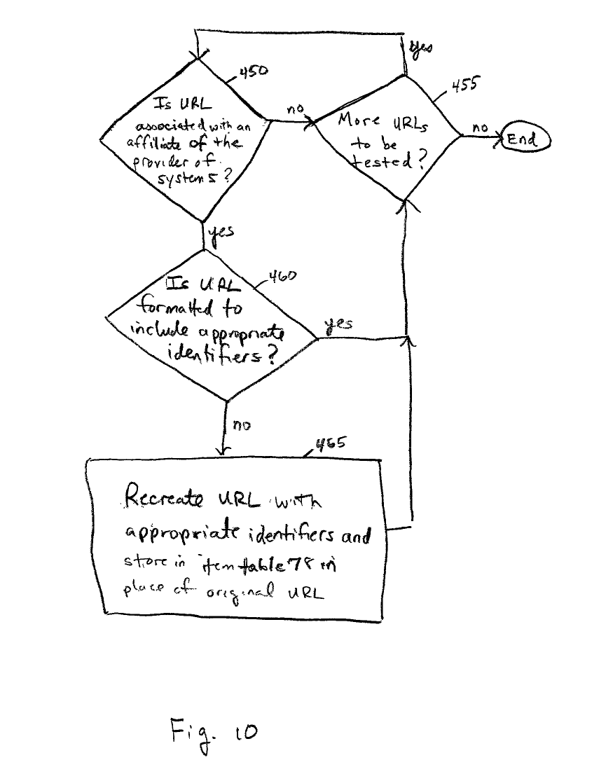

Referring to FIG. 10, a flowchart of a method of ensuring that each URL is so formatted is shown. As shown in box 450 of FIG. 10, a determination is first made as to whether the URL is associated with an affiliate of the provider of system 5. The data scrubbing engine makes this determination by comparing the domain of the URL with a list of affiliated merchants maintained through data server 70 in SAN 75. If the URL is not associated with an affiliate, a determination is made as to whether there are more URLs to be checked, as shown in box 455. If there are no more URLs to be checked, the process ends. If there are more URLs to check, then the process returns to box 450. If, on the other hand, it is determined that the URL is associated with an affiliate of the provider of system 5, then, as shown in box 460, the URL is checked to determine whether it is formatted to include the proper affiliate identification. If the URL is so formatted, then the process returns to box 455 to determine whether there are more URLs to check. If, however, the URL is not properly formatted, then, as shown in box 465, the data scrubbing engine will recreate the URL with the appropriate formatting and will replace the original URL with the recreated URL in the record of item table 78 from which the original URL came. Next, the process returns to box 455 to determine whether there are any more URLs to check. The specific software code required to implement the process shown in FIG. 10 is within the ordinary skill of the art and thus will not be described in detail herein.

What is claimed is:

1. A system for maintaining a plurality of lists, each of said lists being associated with one of a plurality of users and including one or more items desired by the user associated with the list, comprising:
a server for receiving data relating to said one or more desired items over an electronic network from each of said plurality of users;
a data storage device coupled to said server for retrievably storing said data relating to said one or more desired items received from each of said plurality of users;
said server, in response to a request from one of said users, causing a list window to open on a client device under the control of said one of said users, said list window being adapted to display a listing of said one or more desired items included on the list associated with said one of said users;
said server providing said client device with instructions executable by said client device, said instructions, when executed in response to a request from said one of said users to add to the list associated with said one of said users an item shown in a web page being displayed in a first window on said client device, causing said client device to copy a uniform resource locator used to identify said web page from said web page to said list window.

2. A system according to claim 1, wherein when said client device is displaying a plurality of windows, said instructions cause said client device to request said user to choose said first window from a listing of said plurality of windows.

3. A system according to claim 2, wherein said listing of said plurality of windows comprises a list of uniform resource locators.

4. A system according to claim 1, wherein said server is adapted to authenticate said one of said users prior to causing said list window to open on said client device.

5. A system according to claim 1, wherein said client device is adapted to enable said one of said users to input additional information relating to said item shown in said web page into said list window.

6. A system according to claim 5, wherein said client device is adapted to transmit said uniform resource locator and said additional information relating to said item shown in said web page to said server.

7. A system according to claim 6, wherein said data storage device comprises a relational database having a first table having a plurality of first records, each of said first records being associated with one of said lists, and a second table having a plurality of second records, each of said second records being associated with one of said desired items.

8. A system according to claim 7, wherein after said uniform resource locator and said information relating to said item shown in said web page are received by said server, a new second record including said uniform resource locator and said additional information relating to said item shown in said web page is created.

9. A system according to claim 1, wherein said server, in response to a request from a requesting party, causes a second list window to open on one of a client device and a kiosk under the control of said requesting party, said second list window being adapted to display a listing of said one or more items included on the list associated with a selected one of said users.

10. A system according to claim 9, wherein information may not be added to or deleted from said second list window by said requesting party.

11. A system according to claim 9, wherein said listing displayed in said second list window includes selected portions of said data relating to said one or more desired items stored in said data storage device.

12. A system according to claim 11, wherein said selected portions of said data include one or more uniform resource locators.

13. A system for maintaining a plurality of lists, each of said lists being associated with one of a plurality of users and including one or more items desired by the user associated with the list, comprising:
a server for receiving data relating to said one or more desired items over an electronic network from each of said plurality of users;
a data storage device coupled to said server for retrievably storing said data relating to said one or more desired items received from each of said plurality of users;
said server, in response to a request from one of said users, causing a list window to open on a client device under the control of said one of said users, said list window being adapted to display a listing of said one or more desired items included on the list associated with said one of said users;
said server providing said client device with instructions executable by said client device, said instructions, when executed in response to a request from said one of said users to add to the list associated with said one of said users an item shown in a web page having a known template structure being displayed in a first window on said client device, causing said client device to:
(i) locate certain preselected information in the web page based on said known template structure; and
(ii) copy said preselected information from said web page to said list window.

14. A system according to claim 13, wherein when said client device is displaying a plurality of windows, said instructions cause said client device to request said user to choose said first window from a listing of said plurality of windows.

15. A system according to claim 14, wherein said listing of said plurality of windows comprises a list of uniform resource locators.

16. A system according to claim 13, wherein said server is adapted to authenticate said one of said users prior to causing said list window to open on said client device.

17. A system according to claim 13, wherein said preselected information comprises one or more of a uniform resource locator used to identify said web page, a price of said item shown in said web page, and a description of said item shown in said web page.

18. A system according to claim 13, wherein said client device is adapted to enable said one of said users to input additional information relating to said item shown in said web page into said list window.

19. A system according to claim 18, wherein said client device is adapted to transmit said preselected information and said additional information to said server.

20. A system according to claim 19, wherein said data storage device comprises a relational database having a first table having a plurality of first records, each of said first records being associated with one of said lists, and a second table having a plurality of second records, each of said second records being associated with one of said desired items.

21. A system according to claim 20, wherein after said preselected information and said additional information are received by said server, a new second record including said preselected information and said additional information is created.

22. A system according to claim 13, wherein said server, in response to a request from a requesting party, causes a second list window to open on one of a client device and a kiosk under the control of said requesting party, said second list window being adapted to display a listing of said one or more items included on the list associated with a selected one of said users.

23. A system according to claim 22, wherein information may not be added to or deleted from said second list window by said requesting party.

24. A system according to claim 22, wherein said listing displayed in said second list window includes selected portions of said data relating to said one or more desired items stored in said data storage device.

25. A system according to claim 24, wherein said selected portions of said data include one or more uniform resource locators.

26. A system for maintaining a plurality of lists, each of said lists being associated with one of a plurality of users and including one or more items desired by the user associated with the list, comprising:
a server for receiving data relating to said one or more desired items over an electronic network from each of said plurality of users;
a data storage device coupled to said server for retrievably storing said data relating to said one or more desired items received from each of said plurality of users;
said server, in response to a request from one of said users, causing a list window to open on a client device under the control of said one of said users, said list window being adapted to display a listing of said one or more desired items included on the list associated with said one of said users;
said server providing said client device with instructions executable by said client device, said instructions, when executed in response to a request from said one of said users to add to the list associated with said one of said users an item shown in a web page being displayed in a first window on said client device, causing said client device to:
(i) search said web page for one or more preselected patterns of information contained in said web page; and
(ii) when said one or more preselected patterns of information are found, copy certain preselected information associated with said one or more preselected patterns of information from said web page to said list window.

27. A system according to claim 26, wherein when said client device is displaying a plurality of windows, said instructions cause said client device to request said user to choose said first window from a listing of said plurality of windows.

28. A system according to claim 27, wherein said listing comprises a list of uniform resource locators.

29. A system according to claim 26, wherein said server is adapted to authenticate said one of said users prior to causing said list window to open on said client device.

30. A system according to claim 26, wherein said preselected patterns of information comprise one or more of a dollar sign followed by first text information and a body of second text information located in a center portion of said web page.

31. A system according to claim 30, wherein said preselected information comprises said first and second text information, and wherein said first text information relates to a price of said item shown in said web page and said second text information relates to a description of said item shown in said web page.

32. A system according to claim 26, wherein said client device is adapted to enable said one of said users to input additional information relating to said item shown in said web page into said list window.

33. A system according to claim 32, wherein said client device is adapted to transmit said preselected information and said additional information to said server.

34. A system according to claim 33, wherein said data storage device comprises a relational database having a first table having a plurality of first records, each of said first records being associated with one of said lists, and a second table having a plurality of second records, each of said second records being associated with one of said desired items.

35. A system according to claim 34, wherein after said preselected information and said additional information are received by said server, a new second record including said preselected information and said additional information is created.

36. A system according to claim 26, wherein said server, in response to a request from a requesting party, causes a second list window to open on one of a client device and a kiosk under the control of said requesting party, said second list window being adapted to display a listing of said one or more items included on the list associated with a selected one of said users.

37. A system according to claim 36, wherein information may not be added to or deleted from said second list window by said requesting party.

38. A system according to claim 36, wherein said listing displayed in said second list window includes selected portions of said data relating to said one or more desired items stored in said data storage device.

39. A system according to claim 38, wherein said selected portions of said data include one or more uniform resource locators.

40. A system for maintaining a plurality of lists, each of said lists being associated with one of a plurality of users and including one or more items desired by the user associated with the list, comprising:
a server for receiving data relating to said one or more desired items over an electronic network from each of said plurality of users;
a data storage device coupled to said server for retrievably storing said data relating to said one or more desired items received from each of said plurality of users;
said server, in response to a request from one of said users, causing a list window to open on a client device under the control of said one of said users, said list window being adapted to display a listing of said one or more desired items included on the list associated with said one of said users;
said server providing said client device with instructions executable by said client device, said instructions, when executed in response to a request from said one of said users to add to the list associated with said one of said users an item shown in a web page being displayed in a first window on said client device, causing said client device to copy a uniform resource locator used to identify said web page from said web page and transmit said uniform resource locator to said server;
said server storing instructions that, upon receipt of said uniform resource locator, cause said server to:
(i) determine whether said web page has a known template structure;
(ii) if said web page has a known template structure, access said web page using said uniform resource locator and locate certain preselected information in said web page based on said known template structure; and
(iii) copy said preselected information from said web page and store said preselected information in said data storage device.

41. A system according to claim 40, wherein said data storage device comprises a relational database having a first table having a plurality of first records, each of said first records being associated with one of said lists, and a second table having a plurality of second records, each of said second records being associated with one of said desired items.

42. A system according to claim 41, wherein when said preselected information is stored in said data storage device, a new second record including said preselected information is created.

43. A system according to claim 42, wherein said new second record also includes said uniform resource locator.

44. A system according to claim 43, wherein after said preselected information is stored in said database, said server causes said list window to display said uniform resource locator and said preselected information.

45. A system according to claim 44, wherein said server causes said list window to display said uniform resource locator and preselected information in response to said one of said users performing a refresh function on said client device.

46. A system according to claim 40, wherein said preselected information comprises one or more of a uniform resource locator used to identify said web page, a price of said item shown in said web page, and a description of said item shown in said web page.

47. A system according to claim 40, wherein if said web page does not have a known template structure, said instructions cause said server to:
(i) access said web page using said uniform resource locator and search said web page for one or more preselected patterns of information contained in said web page; and
(ii) when said one or more preselected patterns of information are found, copy certain preselected second information associated with said one or more preselected patterns of information from said web page and store said preselected second information in said data storage device.

48. A system according to claim 47, wherein said data storage device comprises a relational database having a first table having a plurality of first records, each of said first records being associated with one of said lists, and a second table having a plurality of second records, each of said second records being associated with one of said desired items.

49. A system according to claim 48, wherein when one of said preselected information and said preselected second information is stored in said data storage device, a new second record including said one of said preselected information and said pre-selected second information is created.

50. A system according to claim 49, wherein said new second record also includes said uniform resource locator.

51. A system according to claim 47, said server causing said list window to display said uniform resource locator and one of said preselected information and said preselected second information.

52. A system according to claim 47, wherein said preselected patterns of information comprise one or more of a dollar sign followed by first text information and a body of second text information located in a center portion of said web page.

53. A system according to claim 52, wherein said preselected second information comprises said first and second text information, and wherein said first text information relates to a price of said item shown in said web page and said second text information relates to a description of said item shown in said web page.

54. A method of detecting and fixing non-functioning uniform resource locators in a database having a plurality of uniform resource locators, comprising the steps of:
(a) making an HTTP request using a selected one of said uniform resource locators;
(b) determining whether an error message is received in response to said request;
(c) if an error message is received, determining whether a web site identified by said selected one of said uniform resource locators has been previously analyzed to obtain information relating to the structure of uniform resource locators associated with the web site;
(d) if the web site has been previously analyzed, determining whether the web site is down;
(e) if said web site is determined to not be down, manipulating said selected one of said uniform resource locators based on the information relating to the structure of the uniform resource locators associated with the web site to form a manipulated uniform resource locator conforming to said structure; and
(f) replacing in said database said selected one of said uniform resource locators with said manipulated uniform resource locator; wherein steps (a) through (f) are repeated for a preselected group of said uniform resource locators.

55. A method according to claim 54, wherein said preselected group of said uniform resource locators comprises all of said uniform resource locators.

56. A method according to claim 54, wherein said preselected group of said uniform resource locators comprises one or more of said uniform resource locators associated with one or more predetermined web sites.

57. A method according to claim 54, wherein said information relating to said structure comprises the use of one or more particular identifiers.

58. A method according to claim 54, wherein said information relating to said structure comprises the use of session level dependencies.

59. A method of fixing a non-functioning uniform resource locator stored in a database, said non-functioning uniform resource locator being associated with a web site that has been analyzed to obtain information relating to the structure of uniform resource locators associated with the web site, comprising the steps of:
manipulating the non-functioning uniform resource locator based on said information relating to said structure using at least one of information taken from said nonfunctioning uniform resource locator and information associated with said non-functioning uniform resource locator stored in said database to form a manipulated uniform resource locator conforming with said structure; and
replacing in said database said non-functioning uniform resource locator with said manipulated uniform resource locator.

60. A method according to claim 59, wherein said information relating to said structure comprises the use of one or more particular identifiers.

61. A method according to claim 59, wherein said information relating to said structure comprise the use of session level dependencies.

62. A method of detecting and fixing non-functioning uniform resource locators in a database having a plurality of uniform resource locators, comprising the steps of:
(a) making an HTTP request using a selected one of said uniform resource locators;
(b) determining whether an error message is received in response to said request;
(c) if an error message is received, determining whether a web site identified by said selected one of said uniform resource locators is down;
(d) if said web site is determined to not be down, progressively creating one or more modified uniform resource locators, wherein a first modified uniform resource locator is created by removing a directory from said selected one of said uniform resource locators and wherein each next modified uniform resource locator is created by removing a directory from a corresponding previous modified uniform resource locator; and
(e) making, after each said modified uniform resource locator is created, an HTTP request using said modified uniform resource locator and determining whether an error message is received in response to said request, wherein if an error message is not received, said creating step terminates and said selected one of said uniform resource locators is replaced in said database by the modified uniform locator for which an error message was not received;
wherein steps (a) through (e) are repeated for a preselected group of said uniform resource locators.

63. A method according to claim 62, wherein said preselected group of said uniform resource locators comprises all of said uniform resource locators.

64. A method according to claim 62, wherein said preselected group of said uniform resource locators comprises one or more of said uniform resource locators associated with one or more predetermined web sites.

65. A method of fixing a non-functioning uniform resource locator stored in a database, comprising the steps of:
progressively creating one or more modified uniform resource locators, wherein a first modified uniform resource locator is created by removing a directory from said uniform resource locator and wherein each next modified uniform resource locator is crated by removing a directory from a corresponding previous modified uniform resource locator; and
making, after each said modified uniform resource locator is created, an HTTP request using said modified uniform resource locator and determining whether an error message is received in response to said request, wherein if an error message is not received, said creating step terminates and said uniform resource locator is replaced in said database by the modified uniform resource locator for which an error message was not received.

66. In an item registry system maintained by a system provider, said system maintaining a plurality of lists, each of said lists being associated with one of a plurality of users and including one or more items desired by the associated user, a method of sharing revenue from the sale of said desired items among said system provider and one or more of a plurality of sellers affiliated with said system provider, comprising the steps of:
receiving and storing data relating to said desired items from said users over an electronic network when said desired items are added to said lists by said users, said data for each of said desired items including an identification of a first seller credited with enticing said user to add said desired item to said user's list;
making said lists available to said users and a plurality of third parties over said electronic network;
receiving and storing data relating to a purchase of one of said desired items from a second seller; and
determining whether said second seller is one of said affiliated sellers;
wherein if said second seller is one of said affiliated sellers, said second seller pays:
(i) a first fee to said system provider, and
(ii) a second fee to said first seller if said first seller is different from said second seller and if said first seller is one of said affiliated sellers.

67. A system for creating and maintaining a plurality of lists, each of said lists being associated with one of a plurality of users and including one or more items desired by the user associated with the list, comprising:
a plurality of client devices for collecting data relating to said desired items, said client devices being connected to an electronic network;
a plurality of kiosks for collecting data relating to said desired items, each of said kiosks being located at or near a merchant location and being connected to said electronic network;
a server for receiving said data relating to said desired items from said client devices and kiosks over said electronic network; and
a data storage device coupled to said server for retrievably storing information relating to said desired items, said information including said data relating to said desired items;
wherein said server, in response to a request to view a selected one of said lists associated with a selected one of said users received over said electronic network from a requesting party, retrieves from said storage device selected pieces of said information relating to said desired items that comprise information relating to the desired items included on said selected one of said lists and transmits said selected pieces of information to said requesting party over said electronic network.

68. A system according to claim 67, wherein said request originates from a client device under the control of said requesting party.

69. A system according to claim 68, wherein said server transmits said selected pieces of information to said requesting party by causing a list window to open on said client device under the control of said requesting party, said list window being adapted to display a listing of said desired items included on said selected one of said lists.

70. A system according to claim 69, wherein said selected pieces of information include one or more uniform resource locators, each of said uniform resource locators being associated with one of said desired items included on said selected one of said lists and wherein said listing includes one or more hyperlinks comprising said one or more uniform resource locators.

71. A system according to claim 67, further comprising a plurality of bar code scanners for collecting at one of said merchant locations bar code information relating to one or more of said desired items, said bar code scanners being adapted to download said bar code information to the kiosk located at or near said one of said merchant locations.

72. A system according to claim 71, wherein the kiosk located at or near said one of said merchant locations is adapted to translate said bar code information into item parameter information, said data relating to said one or more of said desired items comprising said item parameter information.

73. A system according to claim 71, wherein said data relating to said one or more of said desired items comprisies said bar code information, wherein said server is adapted to translate said bar code information into item parameter information, said information relating to said one or more of said desired items stored by said storage device including said item parameter information.

74. A system according to claim 67, further comprising a plurality of bar code scanners for collecting bar code information relating to one or more of said desired items, each of said bar code scanners being adapted to download said bar code information to one or more of said client devices; wherein said data relating to said one or more of said desired items comprises said bar code information, and wherein said server is adapted to translate said bar code information to item parameter information, said information relating to said one or more of said desired items stored by said storage device including said item parameter information.

75. A system according to claim 1, said server further causing an icon to appear on said client device when said list window is obstructed, wherein activation of said icon causes said list window to become unobstructed.

76. A system according to claim 75, said request to add an item comprises activation of said icon.

77. A system according to claim 13, said server further causing an icon to appear on said client device when said list window is obstructed, wherein activation of said icon causes said list window to become unobstructed.

78. A system according to claim 77, said request to add an item comprises activation of said icon.

79. A system according to claim 26, said server further causing an icon to appear on said client device when said list window is obstructed, wherein activation of said icon causes said list window to become unobstructed.

80. A system according to claim 79, said request to add an item comprises activation of said icon.

81. A system according to claim 40, said server further causing an icon to appear on said client device when said list window is obstructed, wherein activation of said icon causes said list window to become unobstructed.

82. A system according to claim 81, said request to add an item comprises activation of said icon.

83. A system according to claim 47, said server further causing an icon to appear on said client device when said list window is obstructed, wherein activation of said icon causes said list window to become unobstructed.

84. A system according to claim 83, said request to add an item comprises activation of said icon.
